(19) United States
(12) Patent Application Publication
(10) Pub. No.: US 2003/0074229 A1
(43) Pub. Date: Apr. 17, 2003

(54) System and method for nonqualified benefit plan design, implementation, and administration

(75) Inventors: Tom Heise, Lake Forest, IL (US); Abdou Touray, Chicago, IL (US)

Correspondence Address: ALTHEIMER & GRAY, TEN SOUTH WACKER DRIVE, SUITE 4000, CHICAGO, IL, 60606-7482, US

(73) Assignee: RiveNet.com, Inc., Chicago, IL

(21) Appl. No.: 09/949,376

(22) Filed: Sep. 7, 2001

Related U.S. Application Data
(60) Provisional application No. 60/292,772, filed on May 22, 2001.

(51) Int. Cl. G06F 17/60

(52) U.S. Cl. 705/4; 705/36

(57) ABSTRACT

A system and method that enables the online customized design, implementation, and administration of non-qualified benefits plans. An online navigator guides a user through features of plan design, implementation and administration. A plurality of reusable design templates are stored in a repository for generating and implementing a multitude of non-qualified benefit plans. Customized plan features, are easily provided by grouping participants according to certain common attributes of the participants. Administration and implementation of the plan is simplified by automatically generating documents providing links to the service providers and transmitting data directly to the service providers.

### CROSS REFERENCE TO RELATED APPLICATION

This application claims the benefit of U.S. Provisional Application Serial No. 60/292,772, filed May 22, 2001, which is incorporated herein by reference.

### BACKGROUND OF THE INVENTION

The present invention relates to benefit plans. Specific exemplary embodiments discussed relate to business methods for the design, implementation, and administration of nonqualified benefit plans.

This invention relates generally to systems and methods for the design, implementation, and administration of compensation/benefit plans, and, more particularly, relates to systems and methods to enable the customized on-line design, implementation, and administration of nonqualified benefit plans. The terms compensation and benefit are used interchangeably in this document and are intended to be construed broadly.

Corporations compensate employees in a variety of ways, the simplest being cash payment. More complex compensation packages include, for example, medical coverage, day care, deferred compensation, and matching. Compensation plans may be generally categorized as nonqualified and qualified.

A Nonqualified Benefit Plan is, generally, a selective benefit plan per U.S. Department of Labor Section 29 CFR 2530.201-2(b) and is subject to Title I of the Employee Retirement Income Security Act of 1974 (ERISA). Section 29 CFR 2530.201-2(b) states it is “A plan which is unfunded and is maintained by an employer primarily for the purpose of providing deferred compensation for a select group of management or highly compensated employees.” While subject to Title I of ERISA, plans that meet the definition of Section 29 CFR 2530.201-2(b) are not subject to the reporting requirements of a “funded” employee benefit plan. In addition, income to the employee and tax deductions for the employer are both generally deferred until the benefits are actually paid.

The advantages and disadvantages of nonqualified plans are perhaps best understood through comparing them with qualified plans.

A qualified plan (for example, a 401(k) plan) is one that meets certain requirements imposed by the Internal Revenue Code. These requirements include minimum coverage and nondiscrimination requirements prohibiting an employer from providing benefits for some employees to the exclusion of others, and limitations on the amount of benefits. There is also a flat annual limit (currently $10,500) on 401(k) plan elective deferrals. In return for compliance with these requirements, certain tax incentives are provided.

Federal law requires that all contributions to qualified plans (such as 401(k) or pension plans) be set aside in trust. This provides participants with added benefit security, as contributions to a qualified plan are no longer subject to the claims of corporate creditors.

In nonqualified plans, however, the company's assets informally fund the plan. That is, a plan sponsor may acquire certain assets to hedge against the future obligations of a nonqualified plan. As mentioned above, a nonqualified plan must remain unfunded in order to avoid ERISA funded plan reporting requirements. Therefore, all assets used to informally fund nonqualified benefits plans must remain assets of the employer. Contributions to the nonqualified plan are not actually set aside in trust, but remain general corporate assets, subject to the claims of corporate creditors.

Because the nonqualified plan is unfunded, the plan liability remains separate from the company's informal funding assets. Even though a participant account can be indexed to a particular rate of return, mutual fund, or selection of funds, and its value tracked accordingly, the company's money is not necessarily invested in those selected funds. Plans that are funded in this manner are termed “Phantom Account Plans” because there is a disjunction between the plan liability and the company's actual assets. The “Phantom Account” is tracked by the employer in order to determine the appropriate distribution amount when payment becomes due.

The traditional, off-line approach to selling nonqualified benefit plans is through a small group of highly trained agents targeting larger public corporations. One of the primary problems with this approach is that the plan design process can be extremely complicated to explain and time consuming to create, and this complexity can act as a barrier to potential clients, particularly in the emerging and middle market. Nonqualified benefit plan design is limited only by the creativity of the plan designer. However, in an environment in which clients have indicated they want programs that are simple to explain, easy to understand, and seamless to administer, the absence of tools to easily design and clearly articulate the plan and demonstrate the administration can actually be a detriment to nonqualified plan sales. Agents often present plan designs that appear more complicated than is actually necessary. A prospective client may end up not buying any plan because the sales process is made overly complicated.

In addition, the traditional implementation process, in which individual plan documents must be prepared and customized for each participant, serves to hamper nonqualified benefit plan participation in the emerging and middle market. The traditional legal process, in which individually drafted legal agreements are prepared by outside counsel, often delays the implementation and enrollment process. It is also excessively expensive. The typical fee is $2,750-$3,000 for the first participant and $275-$500 for subsequent participants. If the plan has two compensation components, the document cost doubles. Hence, individual documents may cost over $1,000 per participant for a 5-life plan. This expense can be prohibitive to companies in the emerging and middle market, which often have relatively few potential participants.

In the traditional, off-line method of nonqualified plan administration, the administrative cost of maintaining complicated nonqualified benefit plans makes them impractical for companies with few potential participants. In addition, the expense of administering a nonqualified plan generally increases with its complexity. As a result, the cost of designing and administering complicated nonqualified benefit plans is generally prohibitive to companies in the emerging and middle market.

As a result of these shortcomings in the currently implemented system for designing, implementing, and administering nonqualified benefit plans, a need exists for an improved system and method for designing, implementing, and administering nonqualified benefit plans for the emerging and middle market. More particularly, a need exists for a simplified, on-line application to enable the design, implementation, and administration of nonqualified benefit plans.

### SUMMARY OF THE INVENTION

As a result of these needs, the present invention is realized in a system and method that enables the online customized design, implementation, and administration of nonqualified benefit plans. By enabling the online design of nonqualified benefit plans, the System makes the act of purchasing, implementing, and administering a nonqualified plan simpler, faster, and less expensive.

In order to accomplish this, the System distills potential plan design complexity down to a number of simple program alternatives. These plan types might include, for example, alternatives such as the following:

Deferred Compensation Plan (Def Comp)—In a Deferred Compensation Plan, the employer enters into an agreement with the employee to permit the employee to defer a certain portion of their compensation until retirement.

Deferred Compensation Plan with Employer Match (Def Comp Match)—A Deferred Compensation Plan with Employer Match functions in essentially the same manner as a standard Deferred Compensation Plan. In a Deferred Compensation Plan with Employer Match, however, the employer agrees to contribute an amount in addition to the compensation that the employee chooses to defer.

Defined Contribution (DC SERP)—In a Defined Contribution Plan, the employer enters into an agreement with the employee, agreeing to make contributions to an account for the employee's retirement. The contributions to the plan are a set amount defined by the employer.

Defined Benefit (DB SERP)—In a Defined Benefit Plan, the employer enters into an agreement with the employee to provide an annual retirement income benefit. The benefit is a set amount defined by the employer.

The System provides an online plan design navigator that guides the user through almost every feature of plan design, dramatically simplifying the sales and selection process and making the product easier to understand for both the planner and the client. Using the online plan design navigator, the user will create a “Case Design” prior to implementing a particular plan. The Case Design will specify certain plan design parameters (for example, corporate and individual tax brackets, assumed mortality age, accounting method, and so on). The Case Design will function as a reusable template for generating and implementing multiple nonqualified benefit plans, each of which can be easily tailored to particular circumstances and needs. The System can provide the Case Design with recommended plan parameters based on input provided by the plan designer. It will allow the user to create and store multiple Case Designs online for each plan type customized for different scenarios.

The System can allow the plan designer to create a “financial model,” based on information entered during plan design, projecting the plan assets and liabilities for all plan years. The model summarizes funding scenarios of the plan with, for example, insurance products and/or taxable accumulation vehicles. The plan designer may also create customized plan presentation materials and documents for any of their designed plans.

The plan designer may customize the grouping of participants within a plan by creating logical groupings of plan participants (“census groups”) defined according to certain common attributes (such as the same age, vesting schedule, retirement age, benefit amount, or other common attribute). Each plan may contain more than one customized group of participants, and a participant within a plan might have membership in more than one customized group of participants associated with the same plan. The System allows the plan designer to create and maintain a repository of customized groupings of plan participants.

In addition to simplifying the nonqualified plan design process, the System simplifies the nonqualified plan implementation process. The System allows a plan sponsor to transfer the Case Design data to the online implementation process, thereby reducing the implementation time. The plan sponsor needs to specify only the implementation specific data (for example, plan effective date, allocation change frequency, and who will have viewing privileges), and may also modify any of the plan data recorded during the Case Design phase. The plan sponsor may also track the status of the plan online as it is being implemented. In addition, in the preferred embodiment the System will facilitate the plan sponsor's access to optional legal services for the plan via an electronic connection to the company's law firm partner, and may utilize executable documents generated electronically through the System to accommodate the plan, thereby curtailing excessive legal costs. The System may also facilitate the plan sponsor's access, for example, to optional tax and accounting services via an electronic connection to the company's partners.

The System can offer administrative services for the plan to the plan sponsor, alleviating the excessive cost of administering nonqualified benefit plans for companies with few plan participants. The System can facilitate access to information provided by financial institution partners on, for example, the various financial products that can be used to informally fund a plan, and may enable the plan sponsor to purchase any of the financial products available from distribution channel partners (that is, organizations of agents or a business entity in the business of distributing financial products) connected with the System. The System will allow plan participants to change current and future account allocations at any time online, alleviating costly administrative expenses while providing greater efficiency, effectiveness and customer satisfaction. The System can enable participants to view the performance of their accounts and the associated plan indices online (typically, mutual funds or fixed rate products are utilized as the “indices” for employee or employer contributions to participant accounts in, for example, a Defined Contribution or Deferred Compensation plan). The System enables the plan sponsor and planner affiliated with the plan, for example, to view the performance of a plan, individual participant accounts within the plan, and associated plan indices online. The plan sponsor can view the performance and information of any of the financial products available from the distribution channel partners. The System may provide an area for a distribution channel partner, for example, to list their financial products. It provides the necessary tools to maintain the information, track the product activity, and summarize competitors' products. The System will provide tools for an Auditor of a client corporation to audit the plans associated with the corporation. The life insurance policy underwriter may receive and review the policy application from a sponsor through the system. They may also use the system to notify the sponsor regarding the status of the policy.

In addition, the System will provide a “Messaging Service,” which will allow users to communicate with other users of the system based on, for example, their Role in the system, the type of the user determining the list of potential recipients. For example, a participant may send a message to other participants associated with the same plan.

A better understanding of the objects, advantages, features, properties and relationships of the invention will be obtained from the following detailed description and accompanying drawings which set forth an illustrative embodiment and which are indicative of the various ways in which the principles of the invention may be employed.

### BRIEF DESCRIPTION OF THE DRAWINGS

For a better understanding of the invention, reference may be had to a preferred embodiment shown in the following drawings in which:

FIG. 1 is a flow chart illustrating an exemplary method for constructing a Case Design for a nonqualified benefit plan.

FIG. 2 is a flow chart illustrating an exemplary method for implementing a nonqualified benefit plan.

FIG. 3 is a flow chart illustrating an exemplary method for logging into the system.

FIG. 4 is a flow chart illustrating an exemplary method for requesting a user account from the system.

FIG. 5 is a flow chart illustrating an exemplary method for creating a user account within the system.

FIG. 6 is a flow chart illustrating an exemplary method for online viewing of the implementation status of a nonqualified benefit plan.

FIG. 7 is a flow chart illustrating an exemplary method for viewing nonqualified benefit plan reports.

FIG. 8 is a flow chart illustrating an exemplary method for viewing reports on life insurance policies that may be used to informally fund nonqualified benefit plans.

FIG. 9 is a flow chart illustrating an exemplary method for accessing specific financial product information.

FIG. 10 is a flow chart illustrating an exemplary method for consolidating the non-qualified plan design, implementation, and administration process into a centralized online application.

DETAILED DESCRIPTION

The following is a detailed description of a system and method for enabling the online design, implementation, and administration of nonqualified benefit plans.

User Account Creation

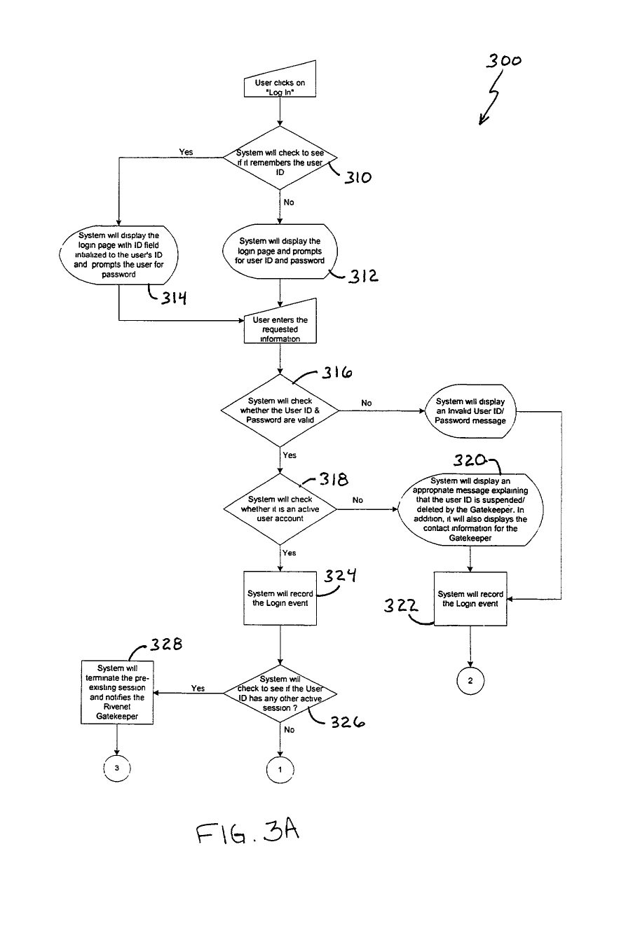

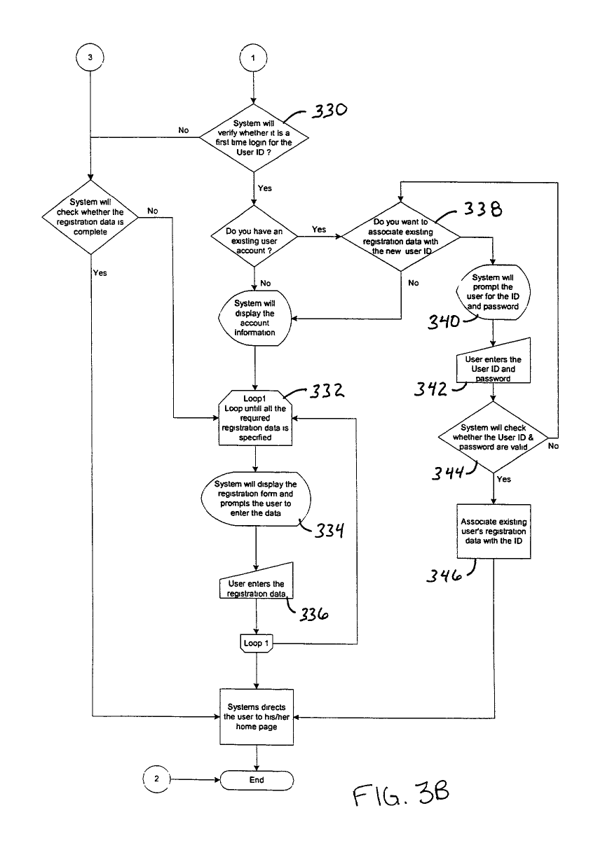

FIG. 4 depicts an exemplary method 400 for requesting a user account from the system, and FIG. 5 illustrates an exemplary method 500 for creating a user account.

In the preferred embodiment, the user account creation system allows for several distinct types of user accounts. Each user account type is intended to accommodate the needs of a specific category of potential user. For example, an employer who is sponsoring a non-qualified benefit plan would utilize a Plan Sponsor account (STEP 510), while an individual employee participating in a nonqualified benefit plan would utilize a Participant account. An insurance agent who wishes to use the system to design a nonqualified benefit plan for a client, for example, would utilize an Agent account (STEP 512).

Each user account type would be associated with different roles within the system; that is, they would have specific privileges and capabilities. Roles might include, for example, such categories as “plan designer,” “plan administrator,” or “account creator.” Someone with a Plan Sponsor account or an Agent account, for example, would be associated with the “plan designer” role, and would be able to use the system to design a nonqualified benefit plan online. A user with a Participant account would not be associated with the “plan designer” role, and would not be able to design an account.

For a description of potential user account types and potential roles within the system, see Appendix A.

In the preferred embodiment of the system an account creator must have an account of their own, as well as permission to create user accounts, in order to create a user account.

The type of user account created can depend upon the role of the account creator. (STEP 410) This will allow, for example, Plan Sponsors to generate accounts for the employees participating in their nonqualified benefit plans (STEP 412), or, for example, Agents to create accounts for the Plan Sponsors that they are designing nonqualified benefit plans for (STEPS 414-416).

If a user selects “request user account” on the company's homepage, for example, the system will function as the account creator (STEP 514).

If a Plan Sponsor is creating the account, for example, the system will set the user classification list to Participant (STEP 516).

If an Agent is creating the account, for example, the system will create a new user account for a Plan Sponsor with the username as the Plan Sponsor's email and a system-generated password (STEP 518). It also assigns default Plan Sponsor role(s), and associates the Plan Sponsor with Agent's specified distribution channel (that is, the organization of agents or business entity in the business of distributing financial products with which the Agent is affiliated).

If a Distribution Channel Gatekeeper is creating the account, for example, the system will create a new user account for an Agent (STEP 520), using the Agent's email address as the user name and providing a system-generated password. It also assigns default Agent role(s), and associates the Agent with a distribution channel.

If the System's Gatekeeper is creating the account, for example, the system will display a list of roles to which the account can be assigned (STEP 522). The System Gatekeeper selects the role(s) for the account. The system will create a new user account with the account owner's email as the username and a system-generated password. It also assigns the specified role(s) to the account owner.

If the system is creating the account, for example, the system will prompt the user to enter the desired User ID and password (STEP 524). When the user enters this information, the system will set the user classification list to Plan Sponsor.

The system will determine the role of the account creator and set the user classification list accordingly.

During the user account creation process, the system may prompt the user to provide user account information (STEP 526). The information requested can be tailored according to the type of user account being created. This will allow, for example, a Plan Sponsor to enter registration information (such as age or date of birth, salary, hire date, etc.) for the employees participating in the nonqualified benefit plan being designed, or, for example, an Agent to enter the associated distribution channel for a newly created Plan Sponsor account.

The system will display information (STEP 530) such as the email address, username, and password for the newly created account, and prompt the account creator to indicate whether the system should notify the account owner that a new account has been created (STEP 528). If the account creator chooses to use the “Messaging Service,” outlined below, the system can send a notification to the account owner (STEP 532) along with the user name and password.

User Registration

FIG. 3 represents an exemplary login process 300. Exemplary login and security steps are represented by STEPS 310-328 (STEP 330). In the preferred embodiment, when the user logs into the system for the first time, the system will present a series of editable fields in which the user will specify detailed registration data, which the system will then record (STEPS 332-336, 338-346). Alternatively, the detailed registration information may be provided in another way (for example, by completing an offline detailed registration form, or through downloading a detailed registration form in PDF or XLS format).

The detailed registration data that is required can be determined according to specific user type. User type may include such categories as Plan sponsor (for example, the employer sponsoring the plan), Agent (for example, an insurance agent designing and selling a plan), or Participant (for example, an employee participating in a plan). See Appendix A for a description of some potential user types and their associated roles within the system.

Corporate-specific plan parameters (for example, company tax bracket or company structure) can be recorded as part of the Plan Sponsor detailed registration. These corporate-specific plan parameters can then be provided as default values when the Plan Sponsor performs a Case Design (see below), thus simplifying the Case Design process.

For example, the information in Table 1 might be required of all users of the system.

TABLE 1

Home Address
City
State
Zip
Phone
Fax

For the Plan Sponsor, for example, the information in Table 2 might be required.

TABLE 2
Title
Employer ID Number
Company Name
Address
City
State
Zip
Company Office Phone
Company Office Fax
Company Tax Bracket
Total number of employees
Company URL
Company Structure—The company can be classified, for example, as Sole
proprietorship, C corporation, S corporation, Partnership, Limited liability
corporation or Not-for-profit.
Fiscal Year End

For an Agent, for example, the additional information in Table 3 might be required.

TABLE 3

Distribution channel

For a Participant, for example, the additional information in Table 4 might be required. The fields labeled “read only” would contain information provided by the Participant's Plan Sponsor during the creation of the Participant account.

TABLE 4

Title
Hire date (read only)
Date of Birth/Age
Tobacco use
Gender
Social Security Number
Company Name (Read Only)
Company Address (Read Only)
Company City (Read Only)
Company State (Read Only)
Company Zip (Read Only)
Company Office Phone (Read Only)
Company Office Fax (Read Only)

For an Auditor, for example, the following additional information in Table 5 might be required.

TABLE 5

Company name

Case Design

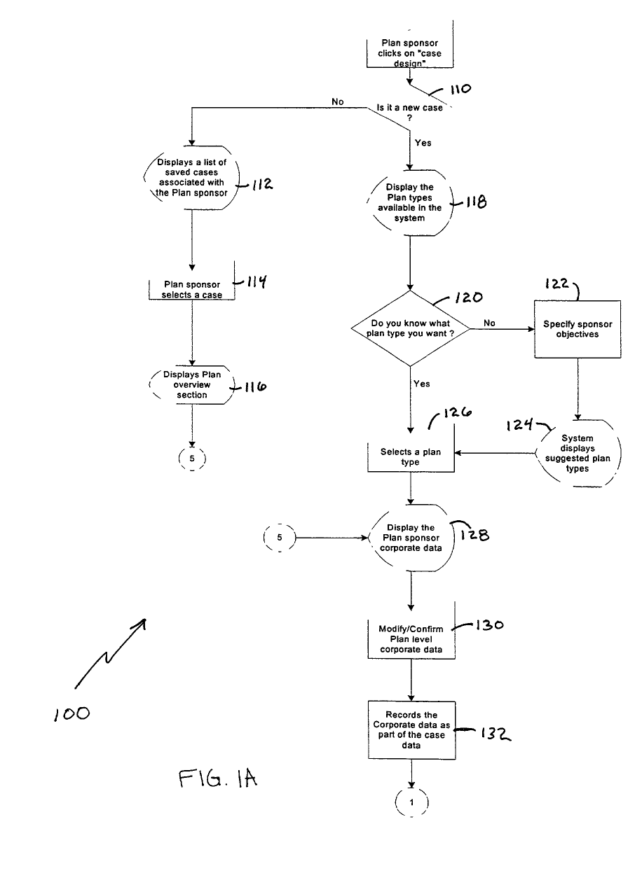

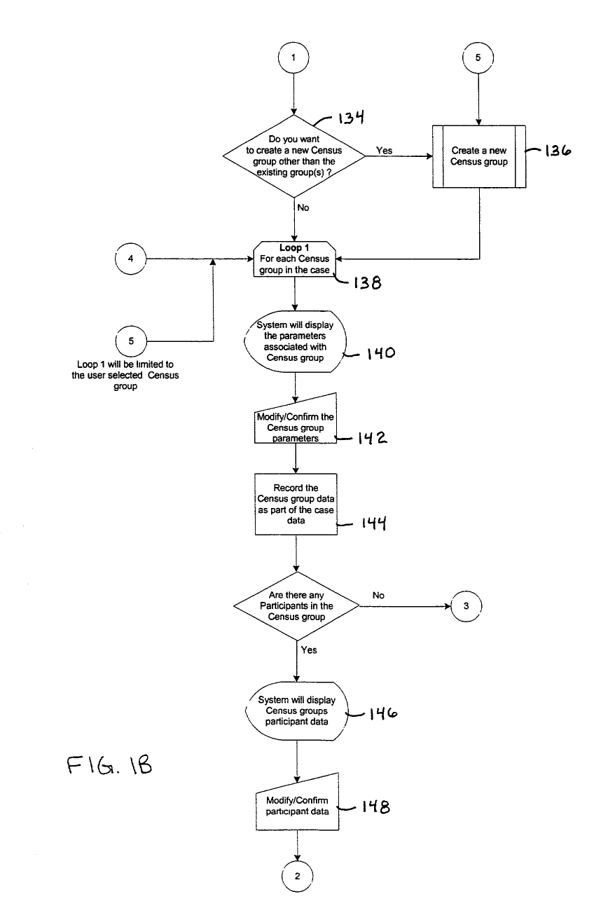

FIG. 1 depicts a process 100 through which the Case Design System allows a Plan Sponsor to design a nonqualified benefit plan online. Before a plan's implementation, that plan is referred to as a “case.” A Case Design consists of a set of plan parameters that have not yet been implemented as an actual nonqualified benefit plan. In the preferred embodiment, on accessing the Case Design System the plan sponsor will be presented with a list of their previously designed cases (if any have been designed) and given the option to modify their design (STEPS 110-116). The Plan Sponsor will also have the option to create a new Case Design.

If the Plan Sponsor chooses to create a new Case Design, the system will display a list of the plan types available in the system—for example, Deferred Compensation, Deferred Compensation with Employer Match, Defined Contribution, or Defined Benefit—with accompanying plan type descriptions for each one (STEP 118). The Plan Sponsor will be prompted to select a plan type and to attach a “Case Name” to the plan type for future retrieval (STEPS 120-126).

When the Plan Sponsor selects a plan type and case name, the system will record the selection of plan type and the user-specified case name. The system will then prompt the user to provide the necessary plan parameters.

These plan parameters might include information such as the following in Table 6.

TABLE 6
Corporation Name
Address
City
State
Zip
Assumed Interest Rate
Corporate Tax Bracket
Participant Tax Bracket
Mortality Age
Aggregation Method—either Traditional or Level Face Aggregation
Accounting method—Can be, for example, either FASB 87 or APB12
Option to treat the Life insurance benefit as endorsement split dollar or
Death Benefit Option benefit

The corporate data for the Plan Sponsor that has been recorded during the user registration process (as outlined above) may also be displayed as default information where appropriate, and the Plan Sponsor can be prompted to modify or confirm this data (STEPS 128-130).

The required plan parameter fields displayed can be customized according to plan type. For example, in the case of Defined Contribution, Deferred Compensation, and Defined Benefit plans, the following additional information in Table 7 might be requested.

TABLE 7

Life Insurance Net Crediting Rate
Taxable Accumulation Vehicle Rate

The system will record the plan parameter data entered by the user (STEP 132). The system can then present the user with a list of available “census groups” (if any have already been created by the user) and the option to create a new customized grouping of plan participants (STEPS 134-136).

If the user selects an available “census group”, the system will list the associated plan implementation parameters by “census group” name, displaying all parameters associated with that group (STEPS 138-140). Such parameters would apply to all participants associated with the particular “census group,” and, for example, might include information such as in Table 8.

TABLE 8
Census Group name
Retirement Age
Distribution Years
Salary scale
Pre-retirement Death Benefit type—options might include, for example,
none, Endorsement Split Dollar, or Death Benefit Only.
Default Death Benefit Amount

Additional information can be displayed appropriate to each plan type. For example, if the plan is Defined Contribution, additional fields might include those in Table 9.

TABLE 9

Vesting
Corporate Contribution

If the plan is Defined Benefit, for example, additional fields might include those in Table 10.

TABLE 10

Benefit amount

If the plan is Deferred Compensation, for example, additional fields might include those in Table 11.

TABLE 11

Maximum deferral
Vesting for employer match
Employer match percentage

The user may modify the “census group” parameters (STEP 142). If the user chooses to create a new customized grouping of plan participants, the system can present the user with a form in which to enter the new customized group parameters, tailored to the plan type. When the user confirms the data, the system can record the “census group” data as part of the case data (STEP 144).

In the preferred embodiment, each case or plan can have multiple customized groupings of participants associated with it, each with their own parameters.

In the preferred embodiment, a participant within the plan can have membership in more than one customized participant group associated with the same plan.

For all participants in the selected customized participant group(s), the system will display a form listing the participant registration data and some plan specific data (STEP 146). This data may include information such as in Table 12.

TABLE 12
Participant Full name
Date of birth or Age
Gender
Tobacco use indicator
Salary
Tax bracket
Deferral-The field would only be displayed in the event of a Deferred
contribution plan.
Contribution-This might be expressed as a fixed amount or as a percent
of salary. This field would be relevant only in the case of a Defined
Contribution plan.
Benefit Amount-This field would only be displayed in the event of a
Defined Benefit plan.

The system will also give the user options to, for example, remove a participant from the plan, edit a participant's information, or add a new participant to the plan (STEPS 148, 150-154). When the user confirms the provided information, the system will record the participant information as part of the case data (STEP 156).

The user can create and store multiple Case Designs for each plan type, each Case Design tailored to specific scenarios. The plan designer can than draw on any of these Case Designs when implementing a particular nonqualified benefit plan, alleviating the need to go through the Case Design process for each nonqualified benefit plan designed.

Financial Model

In the preferred embodiment of the system, the user is given the option of generating a “financial model” in order to prototype the Case Design and informal funding vehicles (STEP 158). Once the user has specified plan parameters, participant specific plan parameters, and corporation specific plan parameters, the user may choose to view a “financial model” that calculates and displays potential future plan liability and potential future value of informal finding vehicles for all plan years. The “financial model” will summarize, for example, scenarios of funding the plan with insurance products and/or funding the plan with taxable accumulation vehicles. The system may also generate sales presentation material consisting of a description of the plan type, composite “financial model,” individual participant “financial model,” and information related to the plan sponsor and participant (STEP 162). The system can also present a summarization of the plan attributes (STEP 160).

By way of example, the following is a description of potential information that might be displayed as part of the “financial model.” For each Participant in the Case, the System would calculate the following values for all plan years depending on the type of the Plan.

TABLE 13
FOR DEFINED CONTRIBUTION PLAN

Participant Account Value
Total Vested Account Value
After-tax Total Vested Account Value
Retirement Benefit
Company Tax Savings
After-tax Informal Funding Cash Flow

TABLE 14
Pre Retirement Life Ins.
Participant Imputed Income (calculated only when the case contains a
pre retirement life insurance benefit to the participants)
Participant After-tax Cost (calculated only when the case contains a
pre retirement life insurance benefit to the participants)

TABLE 15A
FOR DEFERRED COMPENSATION PLAN
WITH EMPLOYER MATCH

Participant Account Value
Employer Match Account Value
Vested Employer Match Account Value
Total Vested Account Value
After-tax Total Vested Account Value
Retirement Benefit
Company Tax Savings
After-tax Informal Funding Cash Flow

TABLE 15B
FOR DEFERRED COMPENSATION PLAN
WITHOUT EMPLOYER MATCH

Participant Account Value
After-tax Account Value
Retirement Benefit
Company Tax Savings
After-tax Informal Funding Cash Flow

TABLE 16
FOR DEFINED BENEFIT PLAN

Accrual Deposit
Plan Liability at the beginning of the year
Interest
Accrued Plan Liability at the end of the year
Retirement Benefit
Company Tax Savings
After-tax Informal Funding Cash Flow
Present Value of After-tax Benefit Obligations
Participant Imputed Income
Participant After-tax Cost

In one embodiment, the System will determine whether the Case is associated with any insurance carrier-specific illustration engine. If the Case is associated with a particular insurance carrier illustration engine, the System will invoke that illustration engine. The system will capture the data in Table 17 from the illustration engine.

TABLE 17
Life insurance death benefit for all plan years
Life insurance cash value for all plan years
Illustration system compliant report. This report must be included along
with other financial model reports.

If the System determines that the Case is not associated with an insurance carrier specific illustration engine, the System will use a generic illustration engine to calculate the values in Table 18 for all plan years.

TABLE 18

Life Insurance Cash Value
Life Insurance Death Benefit

The System will calculate the values in Table 19 for all plan years regardless of the plan type.

TABLE 19

COLI (Corporate Owned Life Insurance) Cash Flow
COLI Death Benefit Proceeds
Corporate Cash Flow Shortfall plus Proceeds
Corporate Cash Account plus Interest
Corporate Cash Account plus Cash Value
Annual change in Corporate Cash Account plus Cash Value
Corporate Cash Account plus Death Benefits
After-tax Taxable Accumulation Account Value
COLI Gain/Loss-Balance Sheet Assets
COLI Gain/Loss-Assets at Death
After-tax Gain/Loss-Balance Sheet Assets
After-tax Gain/Loss-Assets at Death
After-tax Savings From Participant Amount
Incremental Company After-tax Cash Flow
Annual change in After-tax Total Vested Account Value
Annual Effect on Earnings
Cumulative Effect on Earnings

The System will then generate the financial model package. It may contain sections such as the described below.

Plan Modeling Assumptions

This section contains the following information. In the case of a census group level assumption, the information will be listed for each group.

TABLE 20
Plan model preparation date
Plan Effective Date
Corporate Tax Bracket
Salary Scale
Executive tax bracket for each participant
Retirement Age
Retirement Benefit Years
Plan Accumulation/Accrual Rate
Taxable Accumulation Vehicle/Corporate Cash Account Accumulation
Rate
Life Insurance Net Interest Rate
Employer Match—This information would only be displayed for Deferred
Compensation with Employer Match Plan.
Compensation Ceiling on Employer Match—This information would only
be displayed for Deferred Compensation with Employer Match Plan.
Vesting Schedule—This information would only be displayed for Defined
Contribution and Deferred Compensation with Employer Match Plans.
Vesting Schedule is applicable only to Employer contributions.
Accrual Method—This information would only be displayed for Defined
Benefit Plan.
Life Insurance Benefit—It can be a Pre-Retirement life insurance benefit
or a death benefit option benefit. In the case of death benefit option
benefit, the beneficiary of the participant has to pay the taxes and the
company can deduct the amount from the company earnings. In the case of
Pre-Retirement life insurance benefit, the payments are non-taxable and
the company cannot deduct the payment amount from the company
earnings. This is displayed for each participant.
Starting Balance
Type of COLI Funding
Type of Funding Contribution Method
Mortality Age

Participant Benefit Summary

This section consists of the following information

TABLE 21
Participant Name
Age
Salary
Participant Deferral—This information is relevant for both types of
Deferred Compensation Plans
Company Match—This information is only displayed for Deferred
Compensation with Employer Match Plans.
Company Contribution—This information is only displayed for Defined
Contribution Plan.
Annual Retirement Benefit—This information is only displayed for
Defined Benefit Plan.
Pre-Retirement Life Insurance Benefit
In addition, the following plan information is displayed
Plan name
Company name
Corporate tax bracket
Taxable Accumulation Vehicle (TAV) rate—This is the corporation's total
after tax cash flow resulting from the plan and its informal funding.
Plan crediting rate

Participant Models

This section contains the following information. This particular section will be generated for each Participant in the Plan.

TABLE 22
Plan name
Company name
Corporate tax bracket
TAV rate
Plan crediting rate
Participant Name
Starting Age
Retirement Age
Mortality Age
Number of Benefit years
Salary
Salary scale
Initial contribution
Initial company match—This information is only displayed for Deferred
Compensation with Employer match plans.

In addition to the above information, the following values will be listed for all Plan years. The list of data elements may vary depending on the type of the Plan.

TABLE 23
DEFERRED COMPENSATION PLAN
WITHOUT EMPLOYER MATCH

Plan Year
Participant Contribution
Participant Account Value
Total Vested Account Value
After-tax Total Vested Account Value
Retirement Benefit
Company Tax Savings
After-tax Informal Funding Cash Flow
Participant Life Insurance Benefit
Participant Imputed Income
Participant After-tax Cost
Deferred Compensation Plan with Employer Match:
Plan Year
Participant Contribution
Participant Account Value
Employer Match Account Value
Vested Employer Match Account Value
Total Vested Account Value
After-tax Total Vested Account Value
Retirement Benefit
Company Tax Savings
After-tax Informal Funding Cash Flow
Participant Life Insurance Benefit
Participant Imputed Income
Participant After-tax Cost

TABLE 24
DEFINED CONTRIBUTION PLAN

Plan Year
Plan Contribution
Participant Account Value
Total Vested Account Value
After-tax Total Vested Account Value
Retirement Benefit
Company Tax Savings
After-tax Informal Funding Cash Flow
Participant Life Insurance Benefit
Participant Imputed Income
Participant After-tax Cost

TABLE 25
DEFINED BENEFIT PLAN

Plan Year
Accrual Deposit
Beginning of Year Plan Liability
Accrued Interest
End of Year Plan Liability
Retirement Benefit
Company Tax Savings
After-tax Informal Funding Cash Flow
Present Value of After-tax Benefit Obligations
Participant Life Insurance Benefit
Participant Imputed Income
Participant After-tax Cost

Participant Composite

This is the composite of all the Participant Models. This top portion of this section contains the following information

TABLE 26

Plan name
Company name
Corporate tax bracket
TAV rate
Plan crediting rate

The composite of all Participant model values will be listed for all Plan years. The following information in Table 27 is displayed.

TABLE 27

Plan year
Participant contribution
Participant account value
Employer match contribution
Employer match account value
Vested employer match account value
Total vested account value
After tax total vested account value
Retirement benefit
Company tax savings
After tax informal funding cash flow
Participant life insurance benefit
Participant imputed income
Participant after tax cost

COLI Policy Funding Summary

The top portion of this section contains the values in Table 28.

TABLE 28

Plan name
Company name
Corporate tax bracket
TAV rate
Plan crediting rate

In addition, it will also contain the values in Table 29 for all plan years.

TABLE 29

Plan Year
COLI Cash Flow
Cash value
Death Benefit
Policy Death Benefit Proceeds

Participant Underwriting Summary

The top portion of this section contains the values in Table 30.

TABLE 30

Plan name
Company name
Corporate tax bracket
TAV rate
Plan crediting rate

In addition, the values in Table 31 will be listed for all the Participants.

TABLE 31

Plan year
Participant Name
Age
Gender
Tobacco Use
Salary
Policy Face Amount
Premium
Premium Allocation Percent

COLI Informal Funding Summary

The top portion of this section contains the values in Table 32.

TABLE 32

Plan name
Company name
Corporate tax bracket
TAV rate
Plan crediting rate

In addition, it will also contain the values Table 33 for all plan years.

TABLE 33

Plan Year
COLI Cash Flow
Cash value
Death Benefit
COLI Death Benefit Proceeds
After-tax Informal Funding Cash Flow
Corporate Cash Flow Shortfall plus Proceeds
Corporate Cash Account plus Interest
Corporate Cash Account plus Cash Value
Corporate Cash Account plus Death Benefit

Informal Funding Summary

This section summarizes the COLI values with T.A.V account values for all plan years. The top portion of this section contains the values in Table 34.

TABLE 34

Plan name
Company name
Corporate tax bracket
TAV rate
Plan crediting rate

In addition, it will also contain the values in Table 35 for all plan years.

TABLE 35

Plan Year
After-tax Informal Funding Cash Flow
Corporate Cash Account plus Cash Value
Corporate Cash Account plus Death Benefit
After-tax Account Value
Balance Sheet Assets
Assets at Death

COLI Informal Funding Assets to Liability Summary

The top portion of this section contains the values in Table 36.

TABLE 36

Plan name
Company name
Corporate tax bracket
TAV rate
Plan crediting rate

In addition, it will also contain the of values in Table 37 for all plan years.

TABLE 37
Plan year
Total Vested Account Value/End of the Year Accrued Plan Liability
After-tax Value of Vested Accrued Liabilities
After-tax Cost of Benefit Obligations at Death
Corporate Cash Account plus Cash Value
Corporate Cash Account plus Death Benefit
Balance Sheet Assets
Assets at Death

After-Tax Accrued Liability—Effect on Earnings Summary

The top portion of this section contains the values in Table 38.

TABLE 38

Plan name
Company name
Corporate tax bracket
TAV rate
Plan crediting rate

In addition, it will also contain the values in Table 39 for all plan years.

TABLE 39

Plan year
After-tax Informal Funding Cash Flow
After-tax Savings From Participant Deferrals
Incremental Company After-tax Cash Flow
Corporate Cash Account plus Cash Value
Annual Change in Corporate Cash Account plus Cash Value
After-tax Value of Vested Accrued Liabilities
Annual Change in After-tax Value of Vested Accrued Liabilities
Annual Effect on Earnings
Cumulative Effect on Earnings

Pre-Tax Accrued Liability—Effect on Earnings Summary

The top portion of this section contains the values in Table 40.

TABLE 40

Plan name
Company name
Corporate tax bracket
TAV rate
Plan crediting rate

In addition, it will also contain the values in Table 41 for all plan years.

TABLE 41

Plan year
After-tax Informal Funding Cash Flow
After-tax Savings From Participant Deferrals
Incremental Company After-tax Cash Flow
Corporate Cash Account plus Cash Value
Annual Change in Corporate Cash Account plus Cash Value
Pre-tax Value of Vested Accrued Liabilities
Annual Change in Pre-tax Value of Vested Accrued Liabilities
Annual Effect on Earnings
Cumulative Effect on Earnings

Chart-Plan Summary and Informal Funding Summary

This section contains a Graphical representation of data in Table 42 over life of the plan.

TABLE 42

Pre-tax Benefit Plan Liability
After-tax Benefit Plan Liability
COLI Informal Funding Plan Assets
T.A.V Informal Funding Plan Assets

Plan Implementation

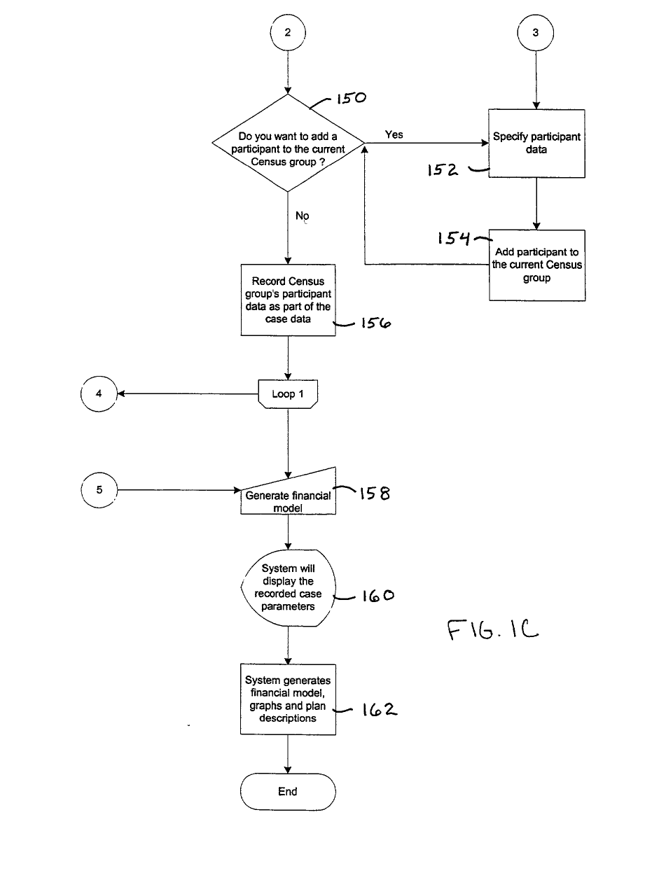

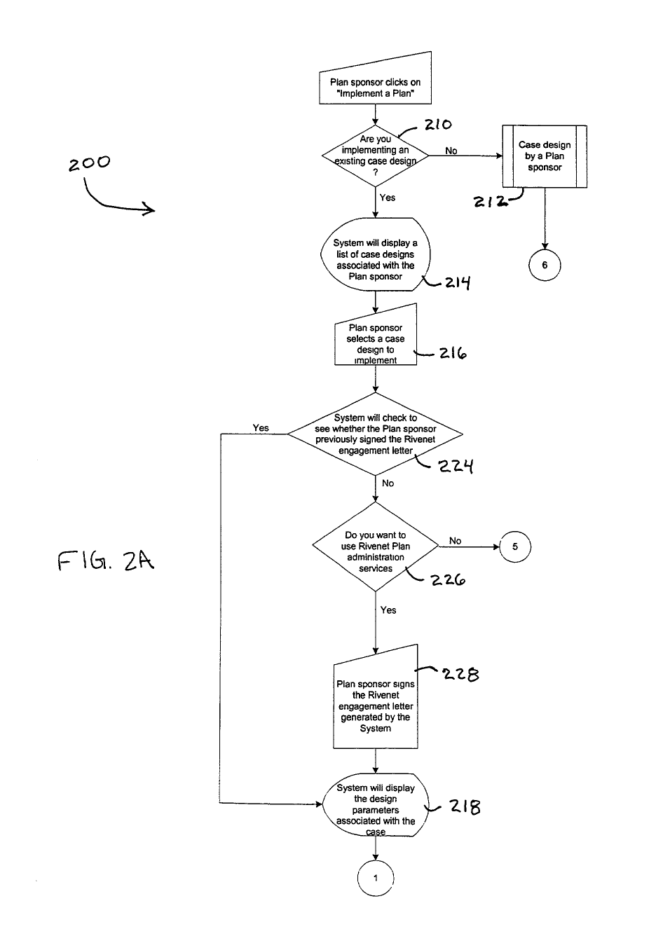

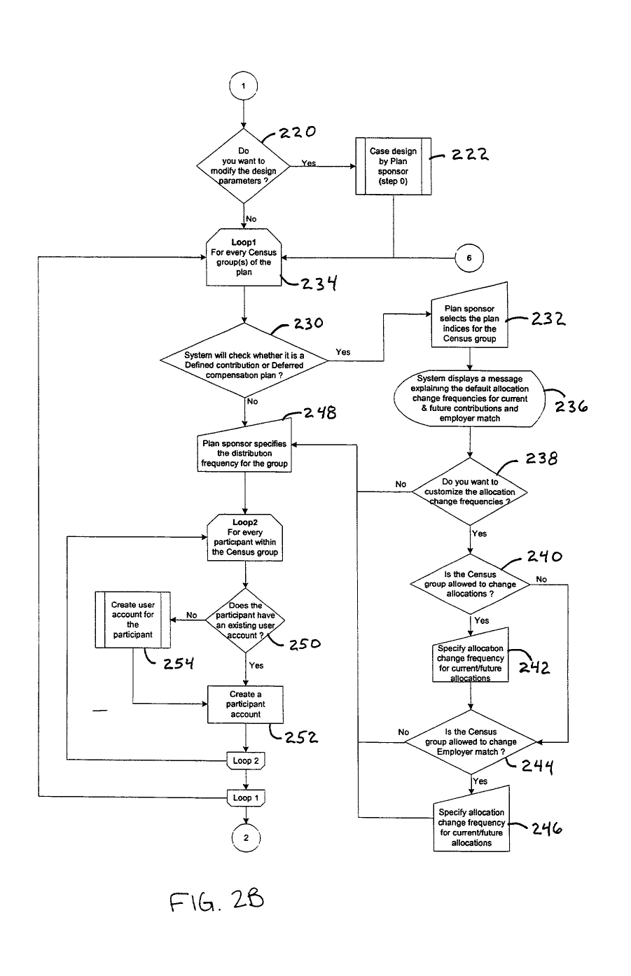

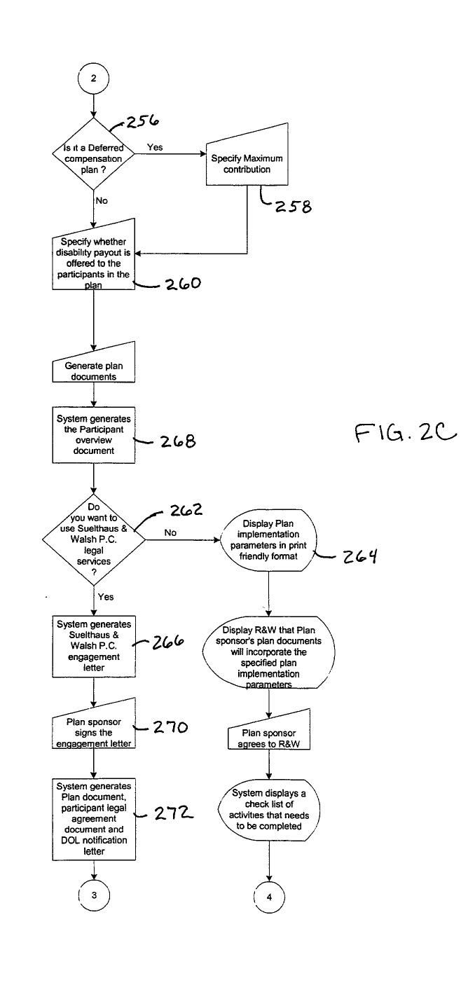

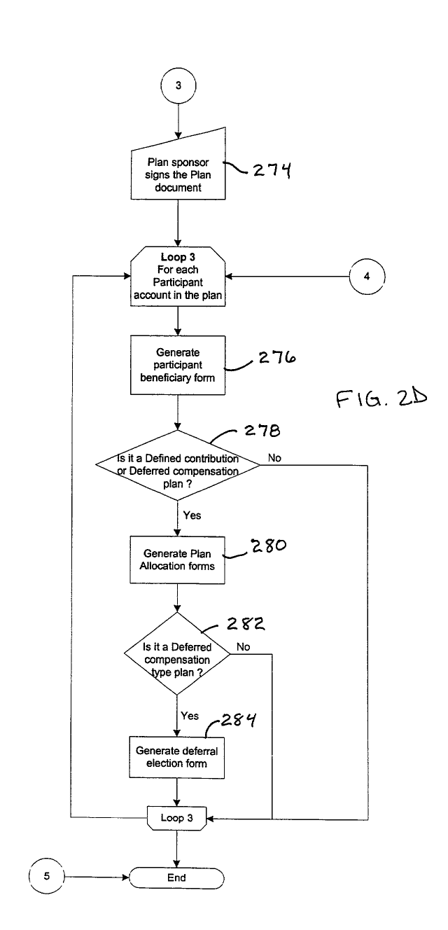

FIG. 2 provides an illustration of an exemplary method 200 for performing the online implementation of a nonqualified benefit plan. By utilizing the information previously gathered through the Case Design process, the Plan Implementation System greatly simplifies the process of implementing a nonqualified benefit plan.

In the preferred embodiment, when a plan sponsor accesses the Plan Implementation System online the system will provide the plan sponsor the option of creating a new Case Design (as explained above) or of implementing one of the existing Case Designs associated with the plan sponsor (STEPS 210-214).

If the user selects an already existing Case Design (STEP 216), the system will utilize the already-recorded design data in the implementation process. The plan sponsor will need to specify only the implementation-specific data. The implementation-specific data may be tailored according to the plan type of the plan being implemented. This implementation specific data may include information such as in Table 43.

TABLE 43
Plan effective date - The date on which the plan is in effect
Disability payout indicator - This indicates whether a payment will
be made to plan participants in the event that they become disabled.
Vesting period start date - In the preferred embodiment, this will default
to the Plan enrollment date. It can be set to either the Plan enrollment date
or the Participant hire date. This field would be applicable, for example, to
Defined Contribution and Deferred Compensation plan with Match
Deferral amount indicator - This field will indicate whether the deferral
amount includes only salary or both salary and bonus. This field would
be applicable, for example, to Deferred Compensation plans.
Annual benefit increase - In the preferred embodiment, this field can
is specified as a percentage. This field is applicable, for example,
to Defined benefit plans
Agent Viewable - By default, the agent has read-only access to the
implemented plan. The plan sponsor may, however, specify that the
agent not have read-only access to the implemented plan.
Allocation change frequency - This field indicates how often allocations
to funds can be changed. The value can be set to default, for example,
to “daily”. The user may also change the frequency, for example,
to one of the following values:
Not to be modified
Daily
Last day of the month
Last day of calendar quarter
Last day of semi-annual
Annually on the last day of the year

The allocation frequency will be the same for current allocations and future contributions as well as employer and employee funds. This field is applicable, for example, to Defined Contribution and Deferred Compensation plan with Match

The plan sponsor may also be given the opportunity to modify the existing plan data, recorded during the Case Design phase (as explained above) (STEPS 218-222).

If the user chooses to implement an existing Case Design, the system will display a list of those Case Designs associated with the plan sponsor and prompt the user to select a Case Design to implement (STEPS 214-216).

When the user selects a Case Design to implement, in the preferred embodiment the system will check whether the plan sponsor has previously signed the client engagement letter with the Company (STEP 224). If the user has not previously signed the client engagement letter with the Company, they can be prompted to choose whether or not they want to use the Company's plan administration services (STEP 226-228).

In the preferred embodiment, if the user chooses not to use the Company's plan administration services, they will be unable to implement the plan (STEP 226). In an alternative embodiment, the user may implement the plan without first having chosen to use the Company's plan administration services.

If the user chooses to use the Company's plan administration services, the system will display the Client Engagement Letter and, in the preferred embodiment, prompt the user to execute the letter with an electronic signature. In an alternative embodiment, the user may print the engagement letter and return a signed copy to the Company.

If the user has previously signed a client engagement letter with the Company, the system will display the design parameters associated with the selected case (STEP 218). The user will be given the option to modify the Case Design parameters before implementing the plan (STEP 220).

When the user confirms the Case Design parameters, the system will check the plan type of the case to be implemented (STEP 230). For certain plan types, the system can prompt the user for further information.

For example, in one exemplary embodiment, if the plan type of the Case Design to be implemented is Defined Contribution or Deferred Compensation, the plan sponsor can be prompted to select the “plan indices” (that is, the financial products that will be made available to plan participants. (STEP 232) These might be, for example, mutual funds or fixed-rate products). These plan indices can be selected for each of the “census groups” affiliated with the plan (STEP 234).

The system may display a message to the user explaining the default allocation change frequencies for current and future contributions and for the employer match, and will prompt the user to indicate whether they want to customize the allocation frequencies for the selected group (STEP 236). If the participants in the “census group” are allowed to change allocations and employer match, the user will be provided the opportunity to specify the allocation change frequency for current and future allocations and employer match (STEPS 238-246).

When allocation change frequencies have been specified, or if the plan type is not Defined Contribution or Deferred Compensation, the plan sponsor will be prompted to specify the distribution frequency for the participants within the selected “census group.” (STEP 248)

For each plan participant within the selected “census group” who has an existing user account, the plan sponsor will be prompted to create a plan participant account (STEPS 250-252). The plan sponsor will also be given the opportunity to create user accounts for plan participants, which will in turn allow the plan sponsor to create a participant account for the participant (STEPS 250, 254).

The system will present the plan sponsor with an online form in which to enter required participant data. Certain additional participant data may be required depending on the plan type. If the plan type is Deferred Compensation, for example, the plan sponsor will be prompted to specify the participant's maximum allowable contribution to the plan (STEPS 256-258). In one embodiment, for all plan types, the plan sponsor will be prompted to specify whether disability payout is to be offered to participants in the plan (STEP 260). When the user enters and confirms the participant data, a participant account will be created and the participant will be added to the plan.

In one embodiment, the user is given the option of using the legal services of the Company's law firm partner(s), access to which is facilitated via an electronic link to the law firm partner(s) (STEP 262). If the user decides not to access legal services provided by the Company's law firm partner(s), the system will inform the user that they will need to provide the Company with their legal documents in order to proceed with plan implementation (STEP 264).

The system will generate executable documents necessary for the implementation of the plan, which may include such documents as a participant overview, Department of Labor letter, and participation letter agreement (STEPS 268-274). Certain plan documents will be generated for particular plan types (STEPS 278-284). If the user has decided to access the legal services of the Company's law firm partner(s), the system will generate a legal plan document in addition to the other plan documents (STEPS 268-272, 276-284).

In the preferred embodiment, the system will give the user the option of either downloading the plan documents as PDFs or having the plan documents emailed to them.

Plan Implementation Status

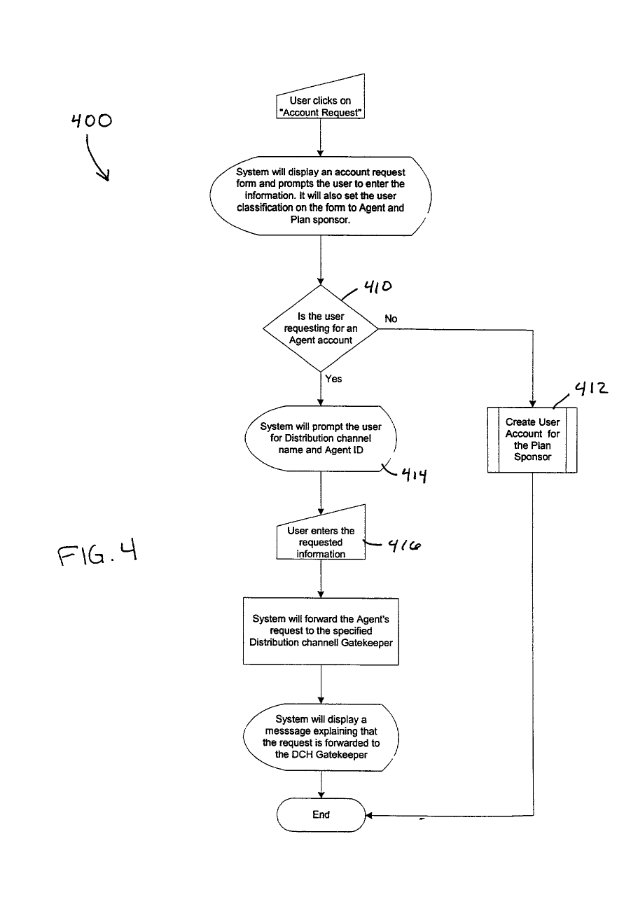

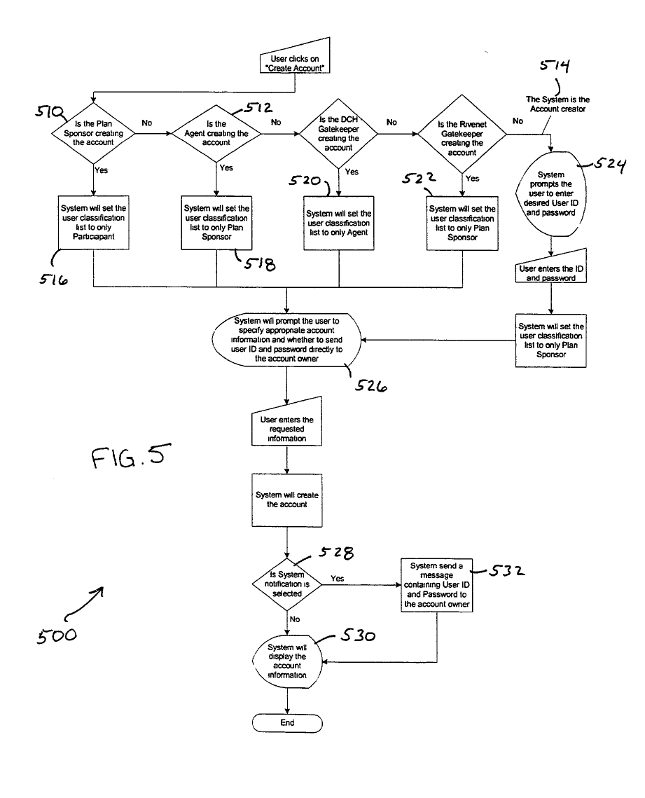

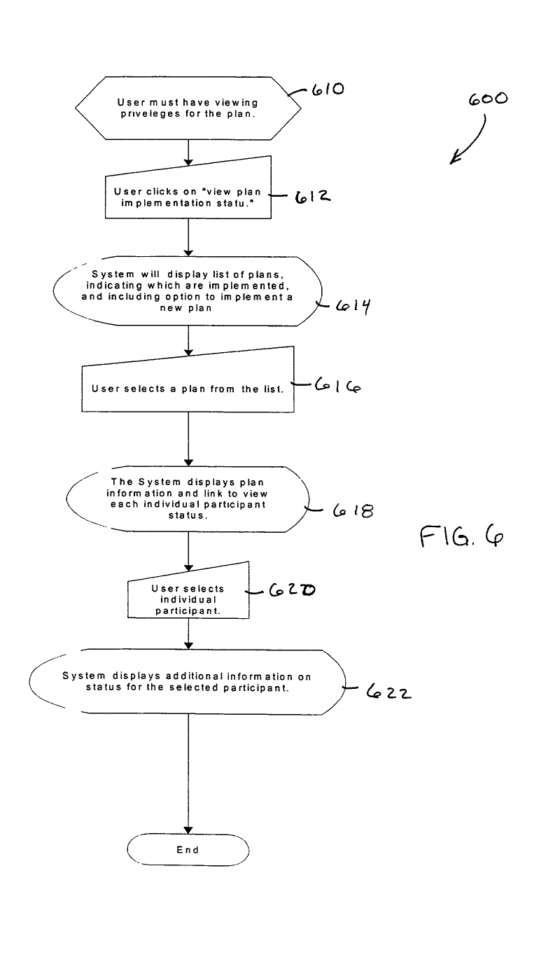

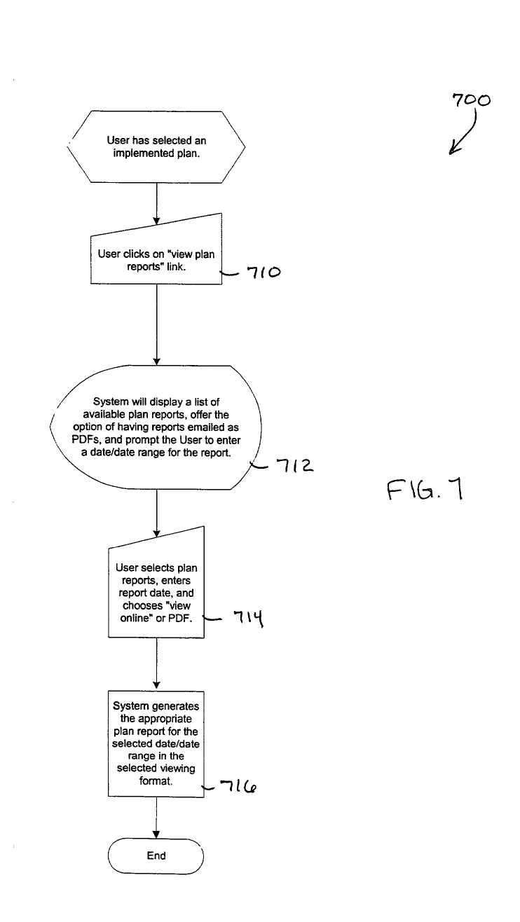

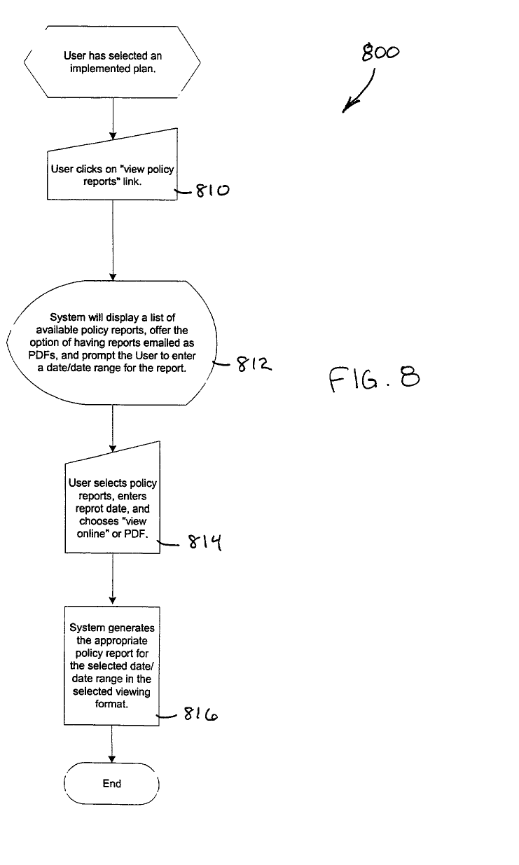

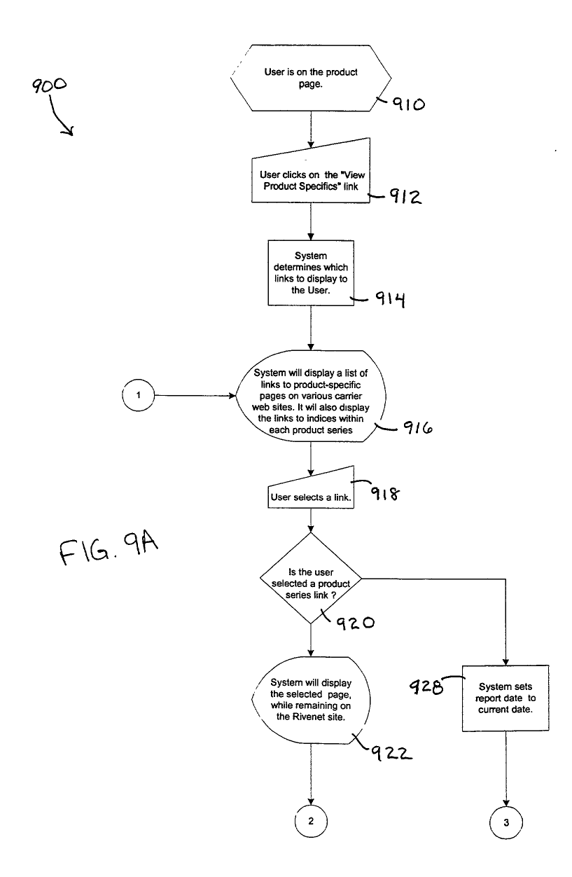

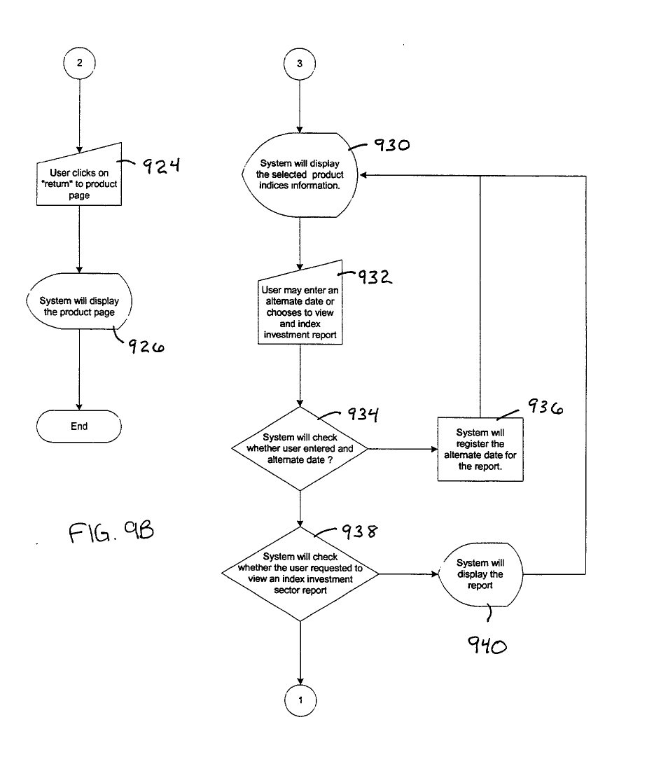

FIG. 6 demonstrates a preferred method 600 for viewing the implementation status of a benefit plan online.

In the preferred embodiment the plan sponsor, or any user with viewing privileges for the plan, will have the ability to view plan implementation status for all plans associated with the user (STEP 610). When the user selects “view plan implementation status,” the system will display a list of those plans associated with the user that are in the implementation process (STEPS 612-614). The system may also provide an option to implement a new plan. When the user selects an individual plan, the system will display the status of the various documents required for the implementation of that plan (STEPS 616-618). The system may provide a link to view the implementation status of each individual plan participant as well (STEPS 620-622).

The information displayed for each plan undergoing implementation might, for example, take the following format in Table 44.

TABLE 44

Plan name
Plan Type
Plan sponsor name
Company name

The form may also contain the sections in Table 45. Each section might have an enumeration of all applicable statuses and (if applicable) the status completion date. The data would be provided to the viewer for informational purposes only and cannot be modified.

TABLE 45
Plan documentations - applicable statuses are ‘Prepared’, ‘Sent’ and
‘Received’
Department of Labor letter - applicable statuses are ‘Prepared’ and ‘Sent’
Participant Asset allocation form - applicable statuses are ‘Prepared’ and
‘Sent’
Participant beneficiary form - applicable statuses are ‘Prepared’ and ‘Sent’
Participant deferral election form - applicable statuses are ‘Prepared’ and
‘Sent’
Engagement letter - applicable statuses are ‘Prepared’, ‘Sent’ and
‘Received’
Participant agreement letter - applicable statuses are ‘Prepared’, and ‘Sent’
Plan summary - applicable statuses are ‘Prepared’, ‘Sent’ and ‘Approved’
Participant overview material - applicable statuses are ‘Prepared’,
‘Sent’ and ‘Approved’
Overall Participant status - applicable status is ‘Completed’.

A separate interface would allow an internal user of the system to update the implementation status for each of the above sections for each plan under implementation.

Messaging

The Messaging System allows users of the system to easily communicate with other users of the system. The system allows users who have an active user account and have completed the detailed user registration to send secure encrypted messages to other users of the system. The system can record information such as the date/time, subject, and body of the message as part of the audit trail. The range of potential recipients of the email can be determined according to the user's role in the system, as outlined below.

The Table 46 lists various potential user account types and their potential message recipients. It will be understood that this list is intended simply as an example of the possible range of user account types and recipients.

TABLE 46

| User Account Type | Recipients |
|---|---|
| System Gatekeeper | Any registered user |
| Distribution Channel | Any Agent, Compliance |
| Gatekeeper | Officer, and Product service representative |
| | associated with the distribution channel os |
| | the DCG. |
| Agent | Agent (within the same distribution |
| | channel), Plan Sponsor, |
| | Distribution/Marketing Manager, |
| | Distribution channel Gatekeeper, CSR and |
| | Product service representative |
| Plan Sponsor | Agent associated with this Plan Sponsor, |
| | Participant, CSR, and Product service |
| | representative. |
| Participant | Plan Sponsor and CSR. |
| Distribution/Marketing | Agent within the distribution channel, |
| Manager | Distribution Channel Gatekeeper and CSR. |

Users can also send messages, for example, to their associated groups within the system. See for example Table 47

TABLE 47
Plan Sponsor can send a message to all participants in a specified plan
Distribution Channel Gatekeeper can send a message to all users within
the Distribution Channel
Gatekeeper can send a message to all active users

The user will also be able to view unread and previously read messages addressed to the user, and will be able to reply to or delete received messages.

Account Management

The Account Management System will allow plan participants to view the performance of their participant accounts and the plan indices (for example, mutual funds or fixed-rate financial products) associated with those accounts. The system will be able to generate a participant statement detailing all account transactions recorded by the system for a date or date range specified by the user. In one embodiment, this participant statement can be displayed online.

The information displayed in the participant statement can be determined according to plan type. For example, an exemplary embodiment of the participant statement might adhere to the following format.

In the case Defined contribution and both types of Deferred compensation plans, the Statement might consist of the following sections and data in the associated tables.

TABLE 48
REPORT INFORMATION SECTION

Participant Name
Beneficiary Name(s)
Report Begin Date
Report End Date
Plan Enrollment Date
Plan Name
Plan type

TABLE 49
ACCOUNT SUMMARY SECTION

Beginning Account Balance
Employer Contributions - This would be relevant only in case of
Deferred Compensation plan with match and Defined Contribution plan.
Employee Contributions - This would be relevant only in case of
Deferred Compensation plan with/without match.
Account Gain/Loss
Ending Account Balance
Vested Percentage - This would be relevant only in case of Deferred
Compensation plan with match and Defined Contribution plan.
Total Vested Benefit - This would be relevant only in case of
Deferred Compensation plan with match and Defined Contribution plan.

TABLE 50
PLAN SUMMARY SECTION

Summary of Plan description

The following values in Table 51 would be listed for each Sub-Account in the selected Participant account grouped by employee and employer contributions. The values displayed could be based on the type of the Plan. The contributions grouped by “employee” would be displayed, for example, only in case of Deferred Compensation plan with/without match. The contributions grouped by “employer” type would be listed, for example, only in case of Defined Contribution plan and Deferred Compensation plan with match.

TABLE 51
FUND SUMMARY SECTION

Sub-Account Name
Unit Value
Number of Units
Sub-Account Value
Sub-Account Percent of Ending Account Balance
Total Value of all Sub-Accounts

In addition to the values, the values in Table 52 would be listed only if there are any employer contributions in the plan.

TABLE 52

Vested percentage
Total vested percentage

The values in Table 53 and sub-sections would be listed for each recorded contribution between the specified reporting period begin and end dates. The contributions would be further grouped by employee and employer contributions.

TABLE 53
HISTORY SECTION

Date when Employee/Employer contribution is made to the Account
Total Employee/Employer Contribution that was made to the Account.

The values in Table 54 would be listed for each of the Sub-accounts that were in the Participant account on the date of contribution.

TABLE 54
Sub-Account name
Allocation percentage
Contribution made to the Sub-Account
Unit price
Number of units purchased
Total Value of all Sub-Account Contributions. This value must be equal to
the above listed Total contribution value.

In the case of Defined benefit plans, for example, the Statement would consist of the following values.

TABLE 55

Participant Name
Beneficiary Name(s)
Plan enrollment date
Annual Benefit Increase
Projected Annual retirement benefit
Number of benefit payments
Retirement Age
Summary of Plan description

It will be understood that the preceding description presents only one potential embodiment of the participant statement, and that the precise format and content of the participant statement can take many alternative forms.

In the preferred embodiment, the Account Management System will allow a plan participant to change current and future allocations to the various available plan indices (for example, mutual funds or fixed-rate financial products) at any time. If the user chooses to reallocate existing balances, the system can determine that the user currently has allocation requests waiting to take effect on the next reallocation date. In the preferred embodiment, the system will display the allocation amounts in percentage form. It will display information such as the next reallocation date, a link to reallocate funds by whole value amounts, an option to “re-balance” the account, the date when the current percentages took effect, and the date when the new percentages were last modified.

The system will display all active sub-accounts in the plan, listing information such as current dollar amount allocated to the sub-account, current percentage of employee total amount, new percentage of employee total amount, and any unallocated amount. Additional information may be displayed depending on the plan type. For example, in the event that the participant is associated with a deferred compensation with match plan, the system can display additional information on employer match amounts.

If the user chooses to reallocate future contributions, the system will display the next reallocation date based on the reallocation frequency selected by the plan sponsor during the plan implementation process, the date when the current percentages took effect, and the date when the new percentages were last modified. In addition, the system will list each active sub-account in the plan, displaying the current percent of total employee contributions, the new percent of total employee contributions (if the user has current reallocations that are yet to take effect, the system will retrieve and display those values). In the event that the participant is associated with a deferred compensation with match plan, the system will display additional information on employer match amounts.

The system can display the values in editable or non-editable fields. In the preferred embodiment, whether values are displayed in editable or non-editable fields will depend on what the plan sponsor has chosen when setting the plan implementation parameters.

The user may modify any of the editable fields. When the user confirms that the changes are correct, the system will save the new allocation amounts.

In the preferred embodiment, the system will allow a plan sponsor to reallocate current and future account allocations for any participants associated with a plan associated with the plan sponsor.

Product Specifics

FIG. 9 illustrates an exemplary method 900 for facilitating access for plan sponsors, agents, and customer service representatives to information provided by the company's financial institution partners on the various financial products that can be used to fund a plan.

This information might include plan information available on an insurance carrier's site, the product prospectus, information relating to service representatives, and so on. By making this information readily accessible in a central location, the system greatly enhances the ease with which users of the system can maintain and administer their plans.

In the preferred embodiment, when the user selects a link to display available product information, the system displays a list of links to product-specific pages on the various carrier web sites (STEPS 912-916). The list of links displayed can be determined according to the individual user's role. For example, if a user is associated with a particular distribution channel, the links displayed can be limited to those that have been associated with that distribution channel. In the preferred embodiment, when the user selects one of these links the system will display the requested page in a pop-up window while remaining on the Company web page (STEPS 918-922). In an alternative embodiment, the user can be transferred directly to the requested page. In another alternative embodiment, the links displayed when the user chooses to view available product information can transfer the user to product-specific information maintained on the Company's website (STEPS 924-926).

The user may also view the performance of available product indices (for example, selected mutual funds or fixed rate products) (STEPS 928-930). These product indices might be broken down, for example, according to categories similar to those in Table 56.

TABLE 56

Current value of the product index
Daily change
Monthly performance
3 month performance
Year to date performance
1, 3, 5 and 10 year performance
Life of fund performance

The system can display the report for a default date (for example, the current date when accessed). The system can also allow the user to set an alternate date for the report (STEPS 932-936).

The system can also, for example, provide the user with a link to view the most recent investment sector report for the selected indices (STEP 938). This investment sector report may be provided by a third-party or may be produced and maintained on the Company's website (STEP 940).

In one embodiment, the system will provide an area for the company's financial partners to list their available financial products. Access to this area can be restricted according to the individual users role in the system (for example, access can be limited to plan sponsors, agents and customer service representatives). The system will also facilitate access to an independent third party's tool to maintain the information, track the product activity, and summarize competitors' products. In the preferred embodiment, the system will allow the plan sponsor to purchase any of the financial products available through the financial partners.

In one embodiment, if a plan sponsor chooses to fund a plan through life insurance policies, for example, the system will allow that policy underwriter to receive and review the policy application from the sponsor online. Alternatively, the policy underwriter can receive and review the policy application via email.

In one embodiment, the policy underwriter will also be able to use the Messaging system to notify the plan sponsor regarding the status of the policy.

Plan and Policy Reports

FIGS. 7 and 8 present an exemplary methods 700 and 800 for accessing one or several plan and policy reports. The system will enable the user to select the reports they wish to view and, in the preferred embodiment, choose whether to view them online or have them emailed as PDF documents (STEPS 710-716, STEPS 810-816).

The system will allow a user to view a series of plan and policy reports detailing the performance of a plan, individual participant accounts within a plan, and associated plan indices. Access to this information can be restricted according to user type. For example, access to these reports can be limited to plan sponsors, agents, and customer service representatives.

In one embodiment, the user will be able to specify a date or date range for the desired plan or policy reports, which the system will subsequently generate. In an alternative embodiment, the user will be able to select from an archive of previously generated plan or policy reports (STEP 714, STEP 814).

The list of available reports may vary according to plan type. For example, in the case of a Defined Benefit Plan, the associated plan reports might include a Benefits Accrual Annual Summary and an Accrual and Liability Summary. In the case of Defined Contribution and Deferred Compensation plans, for example, the associated plan reports might include a Participant Deferral & Allocation Summary, a Plan summary, and a Participant Statement Summary. Potential policy reports might include a Policy Detail Report, a Policy Summary Report, an Aggregate Plan and Policy Allocation Report, a Policy Allocation Report, or others (see Appendix B for samples of potential plan and policy reports).

Auditing

The system will provide on-line tools for an Auditor of a client corporation to audit the plans associated with the client corporation.

An Auditor user account may be created by a Gatekeeper associated with the client company, and will automatically be affiliated with the client company. Alternatively, a System Gatekeeper can also create an Auditor user account and assign a company affiliation to that account.

An Auditor user account would allow its user to view any plan, product or marketing information in the system affiliated with the client company. The Auditor account would not be privileged to modify any part of the system.

The system will contain Auditor-specific interfaces providing the user with ease of access to plan, product, and marketing information for their affiliated client company.

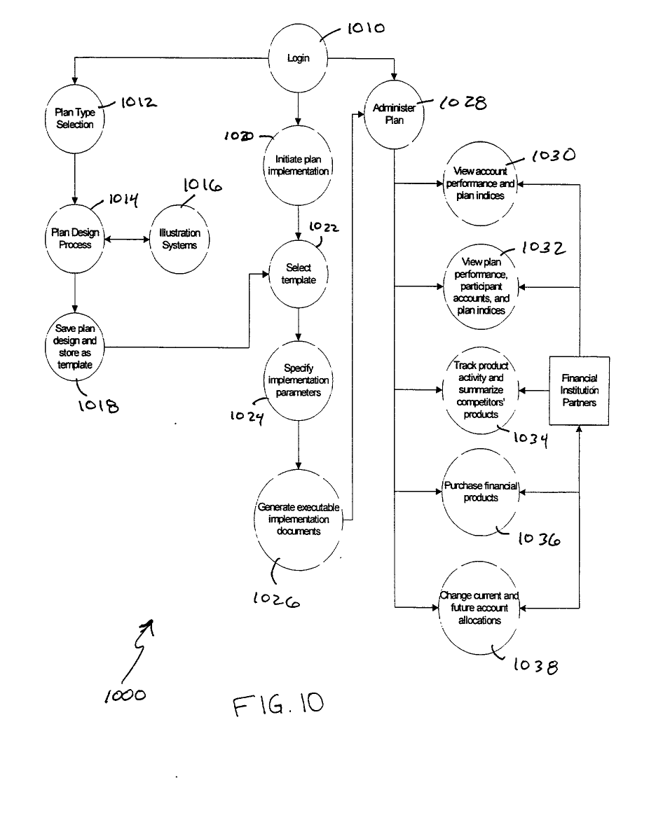

FIG. 10 depicts an exemplary method 1000 for consolidating the non-qualified plan design, implementation, and administration process into centralized online application.

In the preferred embodiment, the process is initiated when a user whose role privileges authorize them to design a Plan logs into the system. (STEP 1010) If the user wishes to design a Plan, the user first selects one of a limited number of Plan Types. (STEP 1012) Depending on the Plan Type selected, the System may automatically supply certain plan design parameters and prompt the user to supply additional design information appropriate to the selected plan type. (STEP 1014) Such information might consist, for example, of corporate and individual tax brackets, assumed mortality age, accounting method, and so on. The user may also be able to enter information pertaining to the potential participants in the plan, and, in the preferred embodiment, may be able to organize the plan participants into various groupings within the plan according to certain common attributes (such as retirement age, salary, and so on).

In one embodiment, the system will make a generic illustration system available to the user, allowing the user to generate a financial model projecting potential future assets and liabilities of the plan as designed. (STEP 1016) In another embodiment, the system will provide a link to the illustration systems of various outside companies, allowing the user to utilize those illustration systems to project potential future assets and liabilities of the plan as designed.

When the user is satisfied with the design parameters, the system allows the user to save the plan design information prior to initiating the plan implementation process. (STEP 1018) The plan design information can then function as a reusable template for generating and implementing multiple nonqualified benefit plans, and in the preferred embodiment may be tailored on implementation to meet specific circumstances and needs.

If the user's role privileges authorize them to implement a plan, the user may do so by selecting a previously designed plan template and initiating the implementation process. (STEPS 1020-1022) Utilizing the information already provided during the on-line plan design process, the system may prompt the user to provide a limited amount of additional, implementation-specific information (for example, plan effective date, allocation change frequency, or other data). (STEP 1024) In addition, the user may be given the option to modify data previously provided during the design process. Incorporating information provided by the user during implementation, the System may, in the preferred embodiment, automatically generate executable implementation documents tailored to the plan. (STEP 1026).

Once the user has finalized the plan implementation process, the System may enable the ongoing on-line administration of the plan according to the parameters specified and recorded during the design and implementation phases. (STEP 1028) The System may, for example, allow plan participants access to view the performance of their individual accounts and associated plan indices on-line, while allowing plan sponsors to view the performance of the plan as a whole, individual participant accounts, and associated plan indices. (STEPS 1030-1032) By facilitating access to information provided by the company's financial institution partners, the System may also allow plan sponsors or participants to track the performance of and compare various financial products that might be used to informally fund the plan. (STEP 1034) The System may also, for example, enable the plan sponsor to purchase any of the financial products available from financial institutions connected with the System. (STEP 1036) In addition, the System may allow plan sponsor and participants to change the current and future allocations of funds associated with the plan at any time online, and, in certain embodiments, communicate that information with those financial institutions associated with the System. (STEP 1038)

While specific embodiments of the invention have been described in detail, it will be appreciated by those skilled in the art that various modifications and alternatives to those details could be developed inlight of the overall teachings to the disclosure. Accordingly, the particular arrangement disclosed is meant to be illustrative only and not limiting as to the scope of the invention which is to be given the full breadth of the appended claims and any equivalents thereof.

[image]

[image]

[image]

[image]

[image]

[image]

[image]

[image]

[image]

[image]

[image]

[image]

[image]

[image]

What is claimed is:

1. A method for designing a non-qualified compensation plan, the method comprising:
displaying a list of non-qualified compensation plan types which are available for implementation;
allowing a user to select one of the non-qualified compensation plan types;
receiving input from a user supplying a first set of parameters for the selected non-qualified compensation plan type;
creating a reusable plan design template for the selected non-qualified compensation plan type including the first set of parameters; and
storing the plan design template in a repository for subsequent use in implementing a non-qualified compensation plan.

2. The method as recited in claim 1, wherein the non-qualified compensation plan types are selected from a group consisting of deferred compensation plans, deferred compensation with employer match plans, defined contribution plans, and defined benefit plans.

3. The method as recited in claim 1, further comprising the step of collecting a second set of parameters during a user registration process and the step of creating the reusable plan design template for the selected non-qualified compensation plan type further comprises including the second set of parameters.

4. The method as recited in claim 1, further comprising the step of displaying customizable parameter fields by which the first set of parameters can be supplied.

5. The method as recited in claim 1, further comprising the step of allowing a user to designate a census group having a second set of parameters and the step of creating the reusable plan design template for the selected non-qualified compensation plan type further comprises using the second set of parameters.

6. The method as recited in claim 1, further comprising the step of generating a financial model of the reusable plan design template.

7. The method as recited in claim 1, further comprising the step of generating presentation material relevant to the reusable plan design template.

8. The method as recited in claim 1, further comprising the step of associating the reusable plan design template with a illustration engine.

9. The method as recited in claim 1, further comprising the step of implementing a non-qualified benefit plan using the reusable plan design template including implementation specific parameters.

10. A method of creating a non-qualified compensation plan, comprising:
retrieving a non-qualified compensation case design from a repository;
receiving implementation specific data from a user;
modifying the retrieved case design based on the received implementation specific data; and
implementing the modified case design.

11. A system for creating non-qualified compensation plans, comprising:
a case design engine for creating reusable non-qualified compensation plan design templates;
a repository associated with the case design engine for storing created non-qualified compensation plan design templates; and
an illustration engine associated with the case design engine for calculating potential future plan liability and potential future value of informal funding vehicles available for use in connection with a created non-qualified compensation plan design template.

12. The system as recited in claim 11, further comprising an implementation engine for accepting data to implement a non-qualified compensation plan selected from the non-qualified compensation plan design templates stored in the repository.

13. The system as recited in claim 12, further comprising a legal services system associated with the implementation engine for providing legal documents necessary for implementing a non-qualified compensation plan.

14. The system as recited in claim 12, further comprising an auditing system associated with the implementation engine for monitoring the financial performance of an implemented non-qualified compensation plan.

15. The system as recited in claim 12, further comprising an account management system associated with the implementation engine for allowing changes to be made to fund allocations in an implemented non-qualified compensation plan.

16. The system as recited in claim 12, further comprising a messaging system whereby participants in implemented non-qualified compensation plans can exchange messages.

17. The system as recited in claim 12, further comprising a fund underwriter system associated with the implementation engine for providing information regarding financial products usable to fund an implemented non-qualified compensation plan.

18. A computer-readable media having instructions for use in designing a non-qualified compensation plan, the instructions performing steps comprising:
displaying a list of non-qualified compensation plan types which are available for implementation;
allowing a user to select one of the non-qualified compensation plan types;
receiving input from a user supplying a first set of parameters for the selected non-qualified compensation plan type;
creating a reusable plan design template for the selected non-qualified compensation plan type including the first set of parameters; and
storing the plan design template in a repository for subsequent use in implementing a non-qualified compensation plan.
